(19) United States
(12) Patent Application Publication
(10) Pub. No.: US 2022/0281006 A1
(43) Pub. Date: Sep. 8, 2022

(54) METAL ALLOYS WITH IMPROVED PROCESSABILITY FOR DIRECT METAL LASER SINTERING

(71) Applicant: EOS GmbH Electro Optical Systems, Krailling (DE)

(72) Inventors: Hannu Heikkinen, Naantali (FI); Antti Mutanen, Turku (FI); Tiina Riskilae, Turku (FI); Maija Nystroem, Turku (FI); Jukka Simola, Loimaa (FI); Eero Virtanen, Littoinen (FI); Antti Poerhoenen, Helsinki (FI); Tatu Syvaenen, Preitilae (FI); Olli Nyrhilae, Kuusisto (FI)

(73) Assignee: EOS GmbH Electro Optical Systems, Krailling (DE)

(21) Appl. No.: 17/594,974

(22) PCT Filed: May 6, 2020
(86) PCT No.: PCT/EP2020/062499

§ 371 Date: Nov. 4, 2021

(30) Foreign Application Priority Data
May 6, 2019 (EP) PCT/EP2019/061585
Nov. 18, 2019 (EP) PCT/EP2019/081572

(51) Int. Cl. B22F 10/28; B33Y 10/00; B33Y 70/00

(52) U.S. Cl. CPC B22F 10/28; B33Y 10/00; B33Y 70/00; B22F 2301/052; B22F 2301/35; B33Y 30/00

(57) ABSTRACT

Disclosed are mixtures for use in additive manufacturing, wherein the powder mixture comprises first and second materials. The first material includes a metal alloy or a mixture of elemental precursors thereof, and is in powder form. The second material includes a reinforcement material comprising powder particles having a particle diameter of from 1 to less than 30 μm (as determined by laser scattering or laser diffraction). The inventive powder mixtures allows for the processing to three dimensions objects which are free of cracking and which thus have favourable mechanical characteristics. Further disclosed are processes for the preparation of corresponding powder mixtures and three dimensional objects, three dimensional objects prepared accordingly and devices for implementing processes for the preparation of such objects, as well as the use of a corresponding powder mixture to suppress crack formation in a three-dimensional object, which is prepared by additive manufacturing.

The invention concerns powder mixtures for use in the manufacture of three dimensional objects by means of additive manufacturing, wherein the powder mixture comprises a first material and a second material. In the respective powder mixtures, the first material comprises a metal alloy or a mixture of elemental precursors thereof, and is in powder form and the second material comprises a reinforcement material comprising powder particles having a particle diameter of from 1 to less than 30 μm (as determined by laser scattering or laser diffraction). The invention further concerns processes for the preparation of corresponding powder mixtures and three dimensional objects, three dimensional objects prepared accordingly and devices for implementing processes for the preparation of such objects, as well as the use of a corresponding powder mixture to suppress crack formation in a three-dimensional object, which is prepared by additive manufacturing.

### STATE OF THE ART

Direct Metal Laser Sintering (DMLS) is a laser-based rapid prototyping and tooling process by means of which net shape parts are fabricated in a single process. Complex parts can be produced directly from 3D-CAD models by layer-wise solidification of metal powder layers in portions of the layer corresponding to the cross-section of the three-dimensional part in the respective layer. This process is described in detail for example in Juha Kotila et al., Steel-based Metal Powder Blend for Direct Metal Laser Sintering Process, Advances in Powder Metallurgy & Particular Materials—1999, Vol. 2 Part 5, p. 87-93 and in T. Syvänen et al., New Innovations in Direct Metal Laser Sintering Process—A Step Forward in Rapid Prototyping and Manufacturing, Laser Materials Processing, Vol. 87, 1999, p. 68 to 76.

A method for producing three-dimensional objects by selective laser sintering or selective laser melting and an apparatus for carrying out this method is disclosed, for example, in EP 1 762 122 A1.

There is a high demand for processing metal materials by additive manufacturing processes such as Direct Metal Laser Sintering, so that rapid manufacturing can be applied to applications where a specific material having well-known properties is required. One important class of materials is steel, which is widely used in many products. Many different kinds of steel exist and are commercially available for conventional manufacturing methods, such as casting, forging, machining etc. as referenced in international standards, reference books, manufacturers' catalogues etc.

Another type of metal materials, which is of particular interest and can be processed with DMLS, is aluminium and aluminium alloys, as they are desirable in applications where light weight is required. Aluminium alloys, which have been described a being suitable for a processing via DMLS, are primarily AlSi materials such as AlSi10Mg, AlSi12, AlSi9Cu3, which, however, suffer from the disadvantage that they have only average strengths (e.g. yield strength of about 200 MPa with low ductility of about 4%) and microstructures.

An exception to this are aluminium alloys of the AlMgSc type as described in EP 3 181 711 A1, which have intermetallic Al—Sc phases providing a strong strength-increasing effect, so that yield strengths of >400 MPa can be achieved. However, these alloys face the difficulty that a relatively high amount of Sc (about 0.6 to 3 wt.-%) is required, which is very expensive. In addition, the material is heavily dependent on the production of sufficient amounts of scandium.

As concerns other metal alloys only a limited variety has yet been described as suitable for additive manufacturing processes, which i.a. include TiAl6V4, CoCr or Incocel 718. These materials have in common that they easily weldable. Like the easily 3D-printable aluminium alloys, these alloys however suffer from low specific strength and fracture toughness in the resulting products.

Most other metal alloys, which are processed by additive manufacture such as DMLS, on the other hand suffer from insufficient properties. This is a result of the melting and solidification dynamics during the printing process, which often leads to intolerable microstructures with large columnar grains and cracks.

In particular, during solidification of alloys such as those in the Al 6000 or 7000 series, the primary equilibrium phase solidifies first at a different composition from the bulk liquid. This results in solute enrichment in the liquid near the solidifying interface, thus locally changing the equilibrium liquidus temperature and producing an unstable, undercooled condition. As a result, solid-liquid interface breaks down leading to cellular or dendritic grain growth with long channels of interdendritic liquid trapped between solidified regions. As temperature and liquid volume fraction decrease, volumetric solidification shrinkage and thermal contraction in these channels produces cavities and hot tearing cracks which may span the entire length of the columnar grain and can propagate through additional intergranular regions.

To obviate these problems, it has been tried to optimize the scan strategies in order to control microstructure, but these strategies are highly material- and geometry-limited and have not provided satisfactory results. In addition, the use of nanoparticles has been described in AlMangour et al. Material and Design 96(2016), pp. 150-161. In this case, the nanoparticles were incorporated into the base metal alloy via ball milling, which makes scale-up and achieving the required uniformity very difficult.

A yet further approach to address the problem of an unfavourable microstructure in a metal alloy due to processing by additive manufacture has been described in WO 2018/144324 A1, where aluminium alloys had been combined with grain refining nanoparticles on the basis of Zr. With these additives, it is claimed that the cracking could be significantly reduced and that a significantly improved tensile strength could be achieved.

The nanoparticles used in WO 2018/144324 have the disadvantage that nanoparticles in general are problematic for health reasons, as the particles, when inhaled, can reach the alveols and then can enter cells and reach the blood stream. In this regard, in some studies it has been shown that inhalation of metal oxides and other nanoparticles in high concentrations can lead to pneumonia, if these fall into the category of so-called granular bio-resistant dusts (GBS). Thus, it is important that unwanted inhalation of nanoparticles is avoided as much as possible which has led to specific regulations and protective measures for workplaces with high dust pollution. Accordingly, many companies are hesitant to work with nanoparticles as this involves the implementation of corresponding regulations and a special education for the staff/workers.

Based on this standing, there is a need for an alternative means to avoid hot cracking during the processing of metal alloys, which does not require the use of nanoparticles. In addition, there is a need for a means which enables the processing of various kinds of metal alloys by means of additive manufacture, and in particular DMLS, which provides processed three dimensional objects of adequate strength and mechanical characteristics.

The present application addresses these needs.

### DESCRIPTION OF THE INVENTION

Accordingly, in a first aspect the present invention concerns a powder mixture for use in the manufacture of a three-dimensional object by means of an additive manufacturing method, wherein the powder mixture comprises a first material of metal alloy or a mixture of elemental precursors thereof and a second material of a reinforcement material comprising powder particles having a d50 particle diameter of from 1 to less than 30 μm (as determined by laser scattering or laser diffraction), wherein the mixture comprises about 0.1 to about 10.0 wt.-% of the second material.

In a preferred embodiment of the above aspect, the powder mixture consists of the first material and the second material. In a further preferred embodiment, powder mixture consists of the first material, the second material and an optional further metal additive as described below.

In the following, some specific metal alloys will be described, where a specific metal is given as a designation of the alloy (e.g. “aluminium” alloy). In this case, the specific metal is meant to contribute for the major part of the alloy, i.e. this metal preferably contributes to at least 60 wt.-%, more preferably at least 70 wt.-% and even more preferably at least 80 wt.-% of the total weight of the metal alloy.

The metal alloy can be used as a metal alloy with the composition of the final metal alloy to be prepared (except for the second material and the optional further metal additive), or can be used as a pre-alloy with one or more, but not all of the constituents of metal alloy to be prepared. In this case, the elements missing the in pre-alloy, relative to the final metal alloy to be prepared, can be added in elemental or alloyed form to form the first material. The term “elemental” in this regard indicates that the material consists of only the respective element, except for unavoidable impurities.

In the alternative, the first material can also contain elemental precursors of a metal alloy to be formed upon processing by means of an additive manufacturing method. In this alternative, the metals are not in the form of an alloy, but are used as the pure precursors of the alloy. To this end, the metals are in elemental form, except for unavoidable impurities found in regular pure metals.

As in this alternative metals are in substantially pure form (i.e. is pure except for unavoidable impurities), it is clear that the first material is not solely constituted of one type of powder particles, but comprises a mixture powder particles of different metals, wherein the entirety of the particles of the first material has the same composition of the final metal alloy (except for the particles of the second material and optional further metal additives). “Substantially pure” in the context of this specification means that the amount of the respective element is preferably at least 98 wt.-%, more preferably at least 99 wt.-%, even more preferably least 99.5 wt.-% and even more preferably least 99.8 wt.-%.

It is possible that the first material comprises substantially pure precursors of each metal to form the final metal alloy or comprises the principle metal of the metal alloy in pure form and one or more particles of mixtures of one or more other metal precursors (i.e. “pre-alloys”) of the final metal alloy. In such mixtures, the metal should conventionally be in a form from which the metals can be converted into the final metal alloy by heating/melting.

In addition, irrespective of whether the first material comprises a metal alloy or a mixture of elemental precursors thereof, it is preferred that the first material does not comprise substantial quantities of non-metal compounds, such as ceramic compounds or precursors of ceramic compound, which during a later processing can react with metal constituents of the metal alloy. Ceramic compounds on heat treatment can regularly not be disintegrated, so that they would remain as introduced in the first material and can potentially disrupt the final form or microstructure of the aluminium alloy to be formed. Thus, in a preferred aspect all the constituents of the first material have the oxidation number 0 and are not present in oxidized form (except for unavoidable impurities). “Substantial quantities of non-metal compounds” is intended to mean a content of equal to or less than 0.1 wt.-% and especially a content of equal to or less than 0.01 wt.-%.

In the investigation underlying this invention, it has been found that in particular the mechanical properties of nickel, steel and aluminium alloys can advantageously be influenced by the addition of a second material as described below, so that in a preferred embodiment the metal alloy is a, nickel, aluminium or steel alloy. A particularly preferred nickel alloy is HX nickel. A particularly preferred steel alloy is H13 steel. Particularly preferred aluminium alloys are aluminium alloys of the 2000, 6000 and 7000 series. Correspondingly, if the first material is a mixture of elemental precursors thereof, the mixture is thus, that upon processing a corresponding aluminium or steel alloy is formed, and in particular thus, that upon processing an aluminium alloy of the 2000, 6000 or 7000 series, a H13 steel alloy or a HX nickel alloy is formed.

If the metal alloy is a steel alloy, a steel alloy comprising up to 10 wt.-% C, 2.0 to 3.0 wt.-% of Mo, 10 to 15.0 wt.-% of Ni and 16.0 to 19 wt.-% of Cr is excluded. In addition 316L grade steel and X3NiCoMoTi18-9-5 steel (classification according to DIN EN 10027-1) is excluded as a steel alloy.

In one particularly preferred embodiment, the first material of the inventive powder mixture comprises iron and 4.75 to 5.5 wt.-% Cr, 1.0 to 1.75 wt.-% of Mo and 0.32 to 0.45 wt.-% of C. Preferably, it further contains 0.8 to 1.25 wt.-% of Si, 0.8 to 1.2 wt.-% of V, 0.2 to 0.6 wt.-% of Mn, p to 0.05 wt.-% of P and 0.05 wt.-% of S. Preferably, the balance to these elements is iron and impurities. Preferably, the impurities do not account for more than 0.5 wt.-% and more preferably not more than 0.2 wt.-% and even more preferably not more than 0.1 wt.-% of the first material.

In another particularly preferred embodiment, the first material comprises nickel and 20.5 to 23 wt.-% of Cr, 17.0 to 20.0 wt.-% of Fe, 8.0 to 10.0 wt.-% of Mo, 0.2 to 1.0 wt.-% of W and 0.5 to 2.5 wt.-% of Co. Preferably, it further contains up to 1.0 wt.-% of Si, up to 1.0 wt.-% of Mn, up to 0.5 wt.-% of Cu, up to 0.5 wt.-% of Al, up to 0.15 wt.-% of Ti and up to 0.2 wt.-%, more preferably from 0.05 to 0.15 wt.-% of Ti. Preferably, the balance to these elements is iron and impurities. Preferably, the impurities do not account for more than 0.5 wt.-% and more preferably not more than 0.2 wt.-% and even more preferably not more than 0.1 wt.-% of the first material.

In another particularly preferred embodiment, the first material comprises aluminium and 4.0 to 5.0 wt.-% Cu, 0.15 to 0.35 wt.-% Ti and 0.15 to 0.35 wt.-% Mg and optionally 0.4 to 1.0 wt.-% Ag. Corresponding mixtures provide an aluminium alloy known as [AlCu4TiMg]). An especially suitable first material of the powder mixture of this embodiment comprises 4.8±0.2 wt.-% Cu, 0.20±0.05 wt.-% Ti and 0.29±0.05 wt.-% Mg and optionally 0.7±0.1 wt.-% Ag. Preferably, the balance to these elements is aluminium and impurities.

In another particularly preferred embodiment, the first material comprises aluminium and 4.0 to 6.1 wt.-% Zn, 1.5 to 3.0 wt.-% Mg, up to 0.8 wt.-% Fe, up to 0.60 wt.-% Si, and one or more of up to 0.35 wt.-% of Cr, up to 0.5 wt.-% of Mn, up to 2.0 wt.-% of Cu, up to 0.30 wt.-% of Ti and 0.1 to 0.25 wt.-% of Zr. With this embodiment it is preferred that the first material comprises less than or equal to 0.25 wt.-% of Cu, less than or equal to 0.35 wt.-% of Cr and 0.05 to 0.5 wt.-% of Mn, and has a combined amount of Mn and Cr which is >0.15 wt.-%. Preferably, the balance to these elements is aluminium and impurities.

In one alternative of this embodiment, it is especially preferred that the first material of the powder mixture comprises aluminium and 1.2 to 2.0 wt.-% Cu, 2.1 to 2.9 wt.-% Mg, 5.1 to 6.1 wt.-% Zn, up to 0.3 wt.-% Cr, and one or more of 0.6 wt.-% Si, up to 0.8 wt.-% Fe, up to 0.3 wt.-% Mn and up to 0.3 wt.-% Ti.

In this alternative, it is preferred that the alloy is substantially free of Si, Fe, Mn and Ti. Corresponding mixtures provide an aluminium alloy known as Al7075. An especially suitable first material of the powder mixture of this alternative comprises 1.6±0.2 wt.-% Cu, 2.5±0.2 wt.-% Mg, 5.6±0.3 wt.-% Zn and 0.23±0.02 wt.-% Cr, and is preferably substantially free of Si, Fe, Mn and Ti. Preferably, the balance to the indicated elements is aluminium and impurities.

“Substantially free” in the context of the above and in this specification means that the respective alloy constituents are present in amounts of less than or equal to 0.1 wt.-%, preferably less than or equal to 0.05 wt.-%, more preferably less than or equal to 0.02 wt.-% and even more preferably less than or equal to 0.01 wt.-%.

In another alternative of this embodiment, it is especially preferred that the first material of the powder mixture comprises aluminium and 4.0 to 5.2 wt.-% Zn, 2.0 to 3.0 wt.-% Mg, up to 0.45 wt.-% Fe, up to 0.50 wt.-% Si, and one or more of up to 0.35 wt.-% of Cr, up to 0.5 wt.-% of Mn, up to 0.1 wt.-% of Ni, up to 0.15 wt.-% of Ti and up to 0.25 wt.-% of Zr. In this embodiment, the combined amount of Mn and Cr is >0.15 wt.-%. It is preferred for this alternative that the alloy comprises less than 0.2 wt.-% Cu, less than 0.1 wt.-% Ni, less than 0.15 wt.-% of Ti and less than 0.35 wt.-% of Cr. Corresponding mixtures provide an aluminium alloy similar to or known as Al7017. An especially suitable first material of the powder mixture of this alternative comprises 4.6±0.3 wt.-% Zn, 2.65±0.3 wt.-% Mg, 0.46±0.05 wt.-% Fe, 0.43±0.05 wt.-% Si, 0.25±0.05 wt.-% of Mn and 0.21±0.05 wt.-% of Zr. Preferably, the balance to the indicated elements is aluminium and impurities.

In yet another particularly preferred embodiment, the first material of the powder mixture comprises aluminium and 0.8 to 1.2 wt.-% Mg, 0.4 to 0.81 wt.-% Si, 0.15 to 0.4 wt.-% Cu, 0.04 to 0.35 wt.-% Cr, one or more of up to 0.7 wt.-% Fe, up to 0.15 wt.-% Mn, up to 0.25 wt.-% Zn and up to 0.15 wt.-% Ti. In this embodiment, it is preferred that the alloy is substantially free of Fe, Mn, Zn and Ti. Corresponding mixtures provide an aluminium alloy known as Al6061. An especially suitable first material of the powder mixture of this embodiment comprises 1.0±0.1 wt.-% Mg, 0.6±0.05 wt.-% Si, 0.25±0.05 wt.-% Cu and 0.2±0.05 wt.-% Cr. Preferably, the balance to the indicated elements is aluminium and impurities.

With regard to the above preferred embodiments it is in one alternative preferred that the first material is present as a powder mixture formed from individual powders of the substantially pure metal precursors, i.e. for example the powder mixture comprises 4.0 to 5.0 wt.-% of a Cu-powder, 0.15 to 0.35 wt.-% of a Ti-powder and 0.15 to 0.35 wt.-% of a Mg-powder and optionally 0.4 to 1.0 wt.-% on an Ag-powder, which the balance being an Al-powder. In another alternative, it is preferred that the first material is present as a powder mixture comprising an aluminium powder and one or more powders of alloys of the other metal precursors.

In yet another particularly preferred embodiment, the first material of the powder mixture comprises aluminium and 1 to 6 wt.-% Fe, 1.3 to 7.5 wt.-% of Cr, and 1.2 to 4 wt.-% of Ti, and optionally up to 0.5 wt.-% of Si and up to 0.1 wt.-% of Mg. An especially suitable first material of the powder mixture of this embodiment comprises 5.0±0.8 wt.-% fe, 3.0±0.5 wt.-% Cr, 1.8±0.3 wt.-% Ti, 0.2±0.08 wt.-% Si, and 0.04±0.02 wt.-% of Mg. Preferably, the balance to the indicated elements is aluminium and impurities.

With regard to the above alloy compositions, it is noted that the principle element therein is iron (if the alloy is a steel alloy) or aluminum (if the alloy is an aluminum alloy). Accordingly, it is preferred that the amount of the iron or aluminum in the respective alloys is at least 60 wt.-%, more preferably at least 70 wt.-% and even more preferably at least 80 wt.-%. It is even more preferred that the iron or aluminum account for the balance to 99 wt.-% with all other metal ingredients of the respective alloy (i.e. at most 1 wt.-% is other undefined elements), with an amount to the balance of 99.5 wt.-% or even to the balance of 100 wt.-% being even more preferred. In this regard, undefined elements can be either metals or non-metals such as C, P, S, or N. Alternatively, the metal alloy, which is described above with the indication “comprising” is also described herein as a metal alloy which “consists of” the indicated elements, except for unavoidable impurities.

In the context of this application, the first material preferably has a d50 particle size distribution of 1 μm or more, more preferably 5 μm or more, still more preferably 10 μm or more, and/or 150 μm or less, more preferably 75 μm or less. In addition, or as an alternative, it is preferred in the invention that the first material has a particle size distribution with a d50 of from of from 20 to 100 μm and preferably 25 μm or more and/or 50 μm or less. The d50 designates the size where the amount of the particles by weight, which have a smaller diameter than the size indicated, is 50% of a sample's mass. Conventionally, as well as in the practice of the invention, the particle size distribution is determined by laser scattering or laser diffraction, e.g. according to ISO 13320:2009.

As indicated above, the first material may be constituted of multiple individual powders, e.g. comprising the substantially pure respective elements, in which case the d50 of the first material is the mean d50 of the powder incorporated into the first material, weighted by the amounts of the respective constituents in the composition. Even though, it is preferred that all of the powders have a particle size is the rage as indicated. More preferably, all powders constituting the first material have a median grain size d50 of 10 to 75 μm, even more preferably in the range of 20 to 60 μm and even more preferably in the range of 25 to 50 μm.

In the practice of the invention, it is furthermore preferred that the particles of the first material are substantially spherical. Corresponding particles can e.g. be prepared by atomization and cooling of the respective element melts. In another preferred embodiment, the particles of the first material are substantially irregular.

In the invention, it is preferred that the second material or “reinforcement material” is a material which is not altered during the thermal processing of the first material. As such materials are predominantly non-metallic materials, the second material in the context of the present invention is preferably a non-metallic material. Suitable non-metallic materials for the purposes of the present invention include in particular carbides, nitrides and borides. Particularly suitable carbides, borides and nitrides include B₄C, TiC, ZrC, Nb₂C, Ta₂C, Al₄C, HfC, TaC, NbC, VC, SiC, B₄C, NbB₂, TaB₂, AlB₂, VN, NbN, AlN, TaN, Nb₂N, Ta₂N and BN. Particular preferred carbides include boron, tungsten, silicon or titanium carbide, wherefrom titanium carbide and boron carbide (B₄C) is most preferred. Particular preferred nitrides include titanium nitride (TiN). Particular preferred borides include e.g. titanium boride (TiB₂).

A further type of materials, which can be employed as the second material are oxides such as aluminium oxide or silicides. As indicated above, the presence of elemental non-metallic materials such as carbon in the melt obtained during the processing of the powder mixture is problematic as these materials can react with the metal constituents of the first material. Therefore, the presence of elemental non-metallic materials should also be avoided in the second material of the inventive powder mixture.

In the context of the invention, it is particularly preferred that the second material consists of at least 80 wt.-%, and especially at least 90 wt.-% of titanium carbide or boron carbide (in particular, when the metal alloy is an aluminium alloy). In one especially preferred embodiment, the second material is titanium carbide.

Even though the amount of the second material can be varied in a relatively broad range of about 0.1 to about 10.0 wt.-%, in most cases the addition of a comparatively low amount of the second material is sufficient to provide the desired effect. The amount of the reinforcement material is thus is regularly 7 wt.-% or less, preferably 5 wt.-% or less, more preferably 3 wt.-% or less and more preferably 2 wt.-% or less, even more preferably 1.2 wt.-% or less, even more preferably 0.75 wt.-% or less, even more preferably 0.6 wt.-% or less and even more even more preferably 0.5 wt.-% or less, in the powder mixture. On the other hand, as noted above, the amount of the second material must be sufficiently high to provide the intended effect of improving the mechanical characteristics. Therefore, in a preferred embodiment, the amount of the second material in the powder mixture is 0.15 wt.-% or more, preferably 0.2 wt.-% or more and more preferably 0.3 wt.-% or more. In some embodiments the minimum amount of the second material can also be 0.5 wt.-%, 1 wt.-% or even 3 wt.-%.

The particle size of the second material should be small enough to ensure an as good as possible uniform distribution of the second material in the powder mixture and the individual portions thereof, which during the additive manufacturing are molten/softened and resolidified. From a health hazard perspective, the particle size d50 of the second material should not be less than 1 μm. It has been found in the investigations underlying the invention that a suitable median grain size d50 of the second material for this purpose is a median grain size d50 of 1 μm or more, preferably 4 μm or more, and/or 100 μm or less and preferably 50 μm or less. In addition, it is preferred that the median grain size d50 of the second material is less than that of the first material.

In one preferred embodiment of the invention, the particles of the second material are substantially irregular; such materials are available e.g. by grinding of corresponding precursor having a larger grain size.

As noted above, next to the first and second material, the inventive powder mixture can in addition comprise a metal powder of Zr and/or Hf as an additive. The presence of such metal powder has been found to further improve the mechanical characteristics of a solid body prepared by processing a corresponding powder mixture by means of additive manufacture and selective laser melting in particular.

Zr and Hf are notoriously tough to separate from each other so that most Zr and Hf metal powders will contain some amount of the respective other element. Thus, in a preferred embodiment, the second material consist of metal powder of Zr and/or Hf.

For the additional metal powder, for the purposes of this invention, it is regularly sufficient that the amount is comparatively small relative to the amount of the first material, i.e. the amount thereof is regularly 8 wt.-% or less, preferably 5 wt.-% or less, more preferably 4.5 wt.-% or less and even more preferably 4.2 wt.-% or less in the powder mixture. On the other hand, the amount of the additional metal powder must be sufficiently high to provide the desired improvement of the mechanical characteristics. Therefore, in a preferred embodiment, the amount of the second material in the powder mixture is 0.1 wt.-% or more, preferably 1 wt.-% or more, more preferably 2 wt.-% or more and even more preferably 2.5 wt.-% or more.

Further, the particle size of the additional metal powder should be small enough to ensure an as good as possible uniform distribution of the additional metal powder in the powder mixture and the individual portions thereof, which during the additive manufacturing are molten/softened and resolidified. In this respect, it has been found in the investigations underlying the invention that a suitable median grain size d50 of the additional metal powder for this purpose is a median grain size d50 of 1 μm or more, preferably 4 μm or more, and/or 100 μm or less and preferably 50 μm or less. In addition, it is preferred that the median grain size d50 of the additional metal powder is less than that of the first material.

The particles of the additional metal powder can have different forms including spherical, flake-like and/or spherically flattened form and the particles can be uniform or irregular. In a preferred embodiment, the particles of the second material are substantially spherical.

A second aspect of the present invention concerns a process for the preparation of a powder mixture as described herein above, wherein the powder mixture is produced by mixing the first material, the second material and the optional reinforcement material in a predetermined mixing ratio. Preferably, the mixing in this process is by dry mixing.

A third aspect of the present invention concerns a process for the manufacture of a three-dimensional object, which is a process for the manufacture of a three-dimensional object from a powder mixture by selective layer-wise consolidation of the powder mixture, and preferably selective layer-wise solidification of the powder mixture by means of an electromagnetic radiation and/or a particle radiation, at positions that correspond to a cross-section of the object in a respective layer, wherein the powder mixture is a powder mixture for use in the manufacture of a three-dimensional object by means of an additive manufacturing method, wherein the powder mixture comprises a first material and a second material powder, wherein the first material comprises a metal alloy or a mixture of elemental precursors thereof and is in powder form, wherein the second material reinforcement material as described above, and wherein the powder mixture is adapted to form an object when solidified by means of an electromagnetic and/or a particle radiation in the additive manufacturing method. Using this method, for example a three-dimensional object with reduced cracking compared to the same three-dimensional object, which is prepared with only the powder of the first material can be manufactured.

Preferably, the process for the manufacture of a three-dimensional object comprises the steps:
providing a powder mixture as defined above, and
preparing the object by applying the mixture layer on layer and selectively solidifying the mixture, in particular by application of electromagnetic radiation, at positions in each layer, which correspond to the cross section of the object in this layer, wherein the positions are scanned in at least one interaction zone, in particular in a radiation interaction zone of an energy beam bundle.

Without being bound by any theory, it is believed that when the particles of the reinforcement material are evenly distributed in the melt of the materials constituting the first material, they influence the solidification behaviour of the cooling melt in a manner that the formation of large grains that shrink during solidification and as a result tear apart from each other causing cracks is significantly reduced or avoided. In direct metal laser sintering, the cooling of the melt is much faster than in conventional manufacturing methods. Thus, the forces created during solidification are greater than e.g. in a conventional casting process.

The three-dimensional object may be an object of a single material (i.e., a material resulting from the processing of the powder mixture as described above) or an object of different materials. If the three-dimensional object is an object of different materials, this object can be produced, for example, by applying the powder mixture of the invention, for example, to a base body or pre-form of the other material.

In the process of the third aspect, by changing the temperature at which the three-dimensional object is prepared together with the reinforcement material particles in the alloy matrix formed during processing the cracking in the final microstructure of metal alloy can be reduced. Thus, in the context of the inventive process, it may be expedient if the powder mixture of the invention is preheated via heating of the building platform to which the powder mixture is applied prior to selective solidification, with preheating to a temperature of at least 100° C. being preferred, preheating to a temperature of at least 120° C. being more preferred, preheating to a temperature of at least 140° C. being even more preferred, and preheating to a temperature of at least 190° C. may be specified as still more preferred. On the other hand, preheating to very high temperatures places considerable demands on the apparatus for producing the three-dimensional objects, i.e. at least to the container in which the three-dimensional object is formed, so that in one embodiment a maximum temperature for the preheating of at most 400° C. and preferably at most 350° C. can be specified.

The amount of energy introduced into the powder mixture should on the one hand be sufficient to soften or melt all components on the first material and provide sufficient thermal energy to allow for the formation of the desired alloy from respective precursors, if necessary. To this purpose, it has been found that the amount of energy per volume of the powder mixture should preferably be 20 J/mm³ or more, and preferably 35 J/mm³ or more. On the other hand, the amount of energy introduced should be kept close to the minimum that is necessary to induce the alloy formation, so that preferably, the amount of energy per volume of the powder mixture should be kept at 140 J/mm³ or less and more preferably 120 J/mm³ or less.

While the inventive process is particularly advantageous as a laser sintering or laser melting process, it can also be implemented as a process, wherein the three dimensional object is formed from the first material, second material and the optional metal powder additive material by application of a binder on each of the individual layers formed, and by consolidating the thus generated pre-forms by sintering to provide the final three-dimensional objects. In this case, the binders are disintegrated to gaseous products, so that the binders are no longer present in the final product.

For the inventive process, it is further preferred that the individual layers, which are subsequently subjected at least in part to treatment with electromagnetic radiation, are applied at a thickness of 10 μm or more, preferably 20 μm or more and more preferably 30 μm or more. Alternatively or cumulatively, the layers are applied at a thickness of preferably 100 μm or less, more preferably 80 μm or less and even more preferably 60 μm or less. In a most preferred embodiment, the thickness, in which the layers are applied, is in the range of 30 to 50 μm.

In the inventive process, it has in addition been found that a heat treatment of the three dimensional object may significantly improve the physical characteristics thereof, e.g. in particular the ultimate tensile strength and the yield strength. Possibly, this effect is due to rearrangements in the microstructure in the alloy of the three dimensional object initially formed, especially when the alloy is an aluminium alloy. To this end, the inventive process preferably further includes a step of subjecting the three-dimensional object initially prepared to a heat treatment, preferably at a temperature from 400° C. to 500° C., and/or for a time of 20 to 200 min. As particularly preferred temperature range a range of 420° C. to 470° C. and especially at least 430° C. and/or 450° C. or less can be mentioned. Particularly preferred time frames for the heat treatment are 30 min to 120 min and especially at least 40 min and/or 80 min or less. In addition, it has been found that such heat treatment provides particularly advantageous results, if after such heat treatment at comparatively high temperature the three dimensional object is quickly cooled to about ambient temperature (i.e. in 10 min or less and preferably 5 min or less, e.g. by quenching with water) and subsequently aged at a temperature of from 90° C. to 150° C., in particular at least 110° C. and/or at 140° C. or less for at least 12 h and preferably at least 18 h. As noted above, such heat treatment is preferably implemented when the alloy is an aluminium alloy.

The three-dimensional object according to a fourth aspect of the invention is a three dimensional object manufactured from a powder mixture by selective layer-wise solidification of the powder mixture by means of an electromagnetic and/or particle radiation at positions that correspond to a cross-section of the object in a respective layer, wherein the powder mixture is a powder mixture for use in the manufacture of a three-dimensional object by means of an additive manufacturing method, wherein the powder mixture comprises a first material and a second material, wherein the first material comprises a metal alloy or a mixture of elemental precursors thereof, wherein the second material comprises a reinforcement material, and wherein the powder mixture is adapted to form an object when solidified by means of electromagnetic and/or particle radiation in the additive manufacturing method. The three-dimensional object has, for example, reduced hot-cracking compared to the same three-dimensional object, which is prepared with only the first material.

Three-dimensional object according to the fourth aspect is preferably constituted of a metal alloy as defined above as a matrix comprising particles of a reinforcement material having a particle diameter of 1 μm to less than 30 μm, wherein the reinforcement material accounts for 0.1 to about 10.0 wt.-% of the three dimensional object.

The three-dimensional object according to the invention in the forth aspect is preferably a three-dimensional object on the basis of an aluminium alloy, wherein the material of the three-dimensional object has an ultimate tensile strength of more than 400 MPa and preferably at least 420 and/or 650 MPa or less, and/or a yield strength of more than 300 MPa and preferably for at least 400 MPa and/or 650 MPa or less, and/or an elongation of equal to or less than 15% and preferably of at least 2 and/or 12% or less.

For specific embodiments of the first material, the second material and the optional further metal additive in the above three-dimensional object, reference is made to the above preferred embodiments which have been described in connection with the inventive powder mixtures.

The amount of second material and the optional further metal additive in the above three-dimensional object can be determined by microscopic measurement of the area occupied by the reinforcement material in a transversal section through the three-dimensional object vs. the area occupied by the metal alloy.

For the three-dimensional object of either of the above, it is preferred that they have a relative density of 98% or more, preferably 99% or more and more preferably 99.5% or more, wherein the relative density is defined as the ratio of the measured density and the theoretical density. The theoretical density is the density which can be calculated from the density of the bulk materials used to prepare the three-dimensional object (basically metal alloy and reinforcement material) and their respective ratios in the three-dimensional object. The measured density is the density of the three-dimensional object as determined by the Archimedes Principle according to ISO 3369:2006.

In a fifth aspect, the present invention concerns the use of a powder mixture as described above for minimizing and/or suppressing crack formation of in a three-dimensional object, wherein the three-dimensional object is prepared in a process involving the step- and layerwise build-up of the three-dimensional object by additive manufacturing, preferably by laser sintering or laser melting.

Finally, in a sixth aspect the present invention concerns a device for implementing a process as described above in the third aspect, wherein the device comprises an electromagnetic radiation application device, preferably as a a laser sintering or laser melting device, a process chamber having an open container with a container wall, a support, which is inside the process chamber, wherein open container and support are moveable against each other in vertical direction, a storage container and a recoater, which is moveable in horizontal direction, and wherein the storage container is at least partially filled with a powder mixture as described in the first aspect.

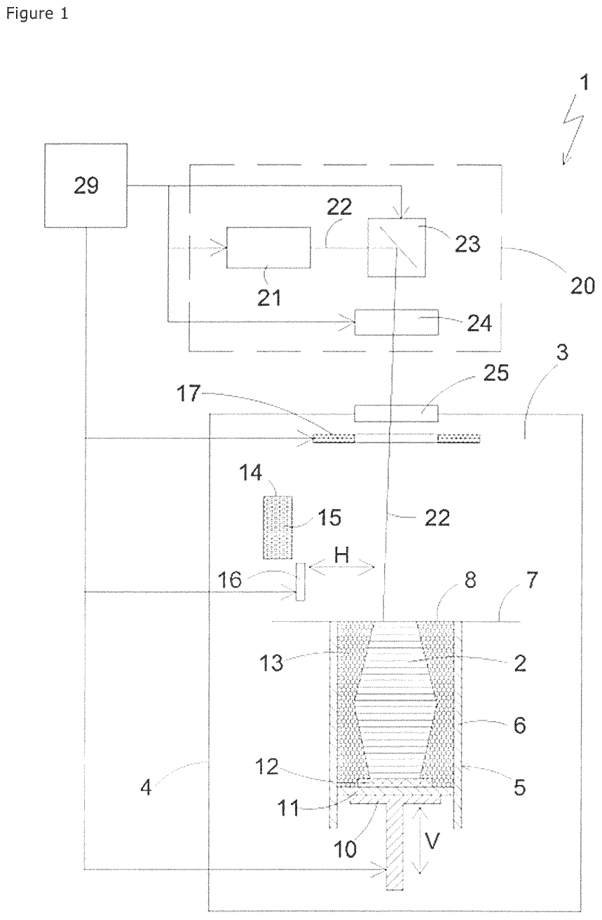

Other features and embodiments of the invention are provided in the following description of an exemplary embodiment taking account of the appended FIG. 1.

The device represented in FIG. 1 is a laser sintering or laser melting apparatus 1 for the manufacture of a three-dimensional object 2. The apparatus 1 contains a process chamber 3 having a chamber wall 4. A container 5 being open at the top and having a container wall 6 is arranged in the process chamber 3. The opening at the top of the container 5 defines a working plane 7. The portion of the working plane 7 lying within the opening of the container 5, which can be used for building up the object 2, is referred to as building area 8. Arranged in the container 5, there is a support 10, which can be moved in a vertical direction V, and on which a base plate 11 which closes the container 5 toward the bottom and therefore forms the base of the container 5 is attached. The base plate 11 may be a plate which is formed separately from the support 10 and is fastened on the support 10, or may be formed so as to be integral with the support 10. A building platform 12 on which the object 2 is built may also be attached to the base plate 11. However, the object 2 may also be built on the base plate 11, which then itself serves as the building platform.

In FIG. 1, the object 2 to be manufactured is shown in an intermediate state. It consists of a plurality of solidified layers and is surrounded by building material 13 which remains unsolidified. The apparatus 1 furthermore contains a storage container 14 for building material 15 in powder form, which can be solidified by electromagnetic radiation, for example a laser, and/or particle radiation, for example an electron beam. The apparatus 1 also comprises a recoater 16, which is movable in a horizontal direction H, for applying layers of building material 15 within the building area 8. Optionally, a radiation heater 17 for heating the applied building material 15, e.g. an infrared heater, may be arranged in the process chamber.

The device in FIG. 1 furthermore contains an irradiation device 20 having a laser 21, which generates a laser beam 22 that is deflected by means of a deflecting device 23 and focused onto the working plane 7 by means of a focusing device 24 via an entrance window 25, which is arranged at the top side of the process chamber 3 in the chamber wall 4.

The device in FIG. 1 furthermore contains a control unit 29, by means of which the individual component parts of the apparatus 1 are controlled in a coordinated manner for carrying out a method for the manufacture of a three-dimensional object. The control unit 29 may contain a CPU, the operation of which is controlled by a computer program (software). During operation of the apparatus 1, the following steps are repeatedly carried out: For each layer, the support 10 is lowered by a height which preferably corresponds to the desired thickness of the layer of the building material 15. The recoater 16 is moved to the storage container 14, from which it receives an amount of building material 15 that is sufficient for the application of at least one layer. The recoater 16 is then moved over the building area 8 and applies a thin layer of the building material 15 in powder form on the base plate 11 or on the building platform 12 or on a previously applied layer. The layer is applied at least across the cross-section of the object 2, preferably across the entire building area 8. Optionally, the building material 15 is heated to an operation temperature by means of at least one radiation heater 17. The cross-section of the object 2 to be manufactured is then scanned by the laser beam 22 in order to selectively solidify this area of the applied layer. These steps are carried out until the object 2 is completed. The object 2 can then be removed from the container 5.

According to the invention, a powder mixture is used as building material 15. The powder mixture comprises a first material and a second material. The first material comprises and is preferably constituted from an metal alloy or a mixture of elemental precursors thereof in powder form. The second material comprises and is preferably constituted from a reinforcement material as described above.

According to the embodiments described below, the powder mixture is processed by the direct metal laser sintering (DMLS) method. In the selective laser sintering or selective laser melting method small portions of a whole volume of powder required for manufacturing an object are heated up simultaneously to a temperature which allows a sintering and/or melting of these portions. This way of manufacturing an object can typically be characterized as a continuous and/or—on a micro-level—frequently gradual process, whereby the object is acquired through a multitude of heating cycles of small powder volumes. Solidification of these small powder portions is carried through selectively, i.e. at selected positions of a powder reservoir, which positions correspond to portions of an object to be manufactured. As in selective laser sintering or selective laser melting the process of solidification is usually carried through layer by layer the solidified powder in each layer is identical with a cross-section of the object that is to be built. Due to the small volume or mass of powder which is solidified in a given time span, e.g. 1 mm³ per second or less, and due to conditions in a process chamber of such additive manufacturing machines, which can favour a rapid cool-down below a critical temperature, the material normally solidifies quickly after heating.

In conventional sintering and casting methods one and the same portion of building material is heated up to a required temperature at the same time. A whole portion of material required to generate an object is cast into a mould in a liquid form. This volume of building material is therefore held above a temperature level required for melting or sintering for a much longer time compared to the selective laser sintering or selective laser melting method. Large volumes of hot material lead to a low cooling rate and a slow solidification process of the building material after heating. In other words, selective laser sintering or selective laser melting methods can be differentiated from conventional sintering and casting methods by processing of smaller volumes of building material, faster heat cycles and less need for heating up build material with high tolerances for avoiding a premature solidification of the material. These can be counted among the reasons why the amount of energy introduced into the building material for reaching the required temperatures can be controlled more accurately in selective laser sintering or selective laser melting methods. These conditions allow for setting an upper limit of energy input into the powder portions to be processed, which determines a temperature generated in the powder portions, more precisely, that is lower and closer to the melting point of the respective material than in conventional sintering or casting methods.

This advantage makes it possible to minimize common problems of conventional sintering and casting methods. One such phenomenon is dissolution of reinforcement material in a metal melt during manufacturing, especially if a resulting material is thermodynamically unstable. The selective laser sintering or selective laser melting method allows for reducing dissolution by lowering the heating temperatures, for example generated by a laser and/or electron beam, in defined areas of the powder bed and for raising a cooling rate after heating. Thus, the reinforcing quality of the reinforcement material, i.e. its ability to change (mechanical) properties of an object in a favourable manner, can become much more apparent. The phrase “mechanical properties of an object” is understood in this context as properties which derive from material properties of the object and not from a specific shape and/or geometry of the object. Mechanical properties of the object can be tensile strength or yield strength, for example.

An object generated from a powder mixture according to the invention may show a change of various mechanical properties, but most notably shows a suppression of crack formation. The inventive method of manufacturing a three-dimensional object thus may provide considerable advantages by improving the mechanical properties compared to an object manufactured without the reinforcement material. Further, a comparatively short exposure of the building material or the processed material to high temperatures leads to a minimization of the dissolution of the optional reinforcement material in the metal alloy material. Furthermore, chemical reactions of the reinforcement material with the metal alloy material are minimized. This is important as the reaction products are generally brittle. If the layer of the reaction product is thick, a considerable weakening of the material can occur.

In the following, the present invention is further illustrated by mean of examples, which however should not be construed as limiting the invention thereto in any manner.

### EXAMPLES

### Example 1: Preparation of Test Bodies of H13 Steel with and without Ceramic Powder

A powder mixture was prepared by introducing non-melting ceramic TiC particles (d50 value was 1.4 μm) into the H13 steel alloy matrix. The amount of ceramic particles added was 0.4 weight percent of the mixture. As the H13 steel alloy, EOS H13 powder (chemistry according H13 standard) was used.

The powder mixture was subsequently used to prepare test bodies. As a comparison, an identical test body was prepared using only EOS H13 powder.

The test body using only EOS H13 powder was prepared at a platform temperature of 200° C. From a micrograph taken from the test body it was apparent that the test body had visible cracking.

A series of test bodies was prepared using powder mixtures with a TiC particle content of either 0.2 wt.-% or 0.4 wt.-%. As in the test body using only EOS H13 powder, the 0.2 wt.-% and 0.4 wt.-% TiC particle containing powder mixtures were used for the preparation of test bodies at a platform temperature of 200° C. In addition, the 0.4 wt.-% ceramic particle containing powder mixture was also used for the preparation of test bodies at 175° C., 165° C. and 150° C.

The thus prepared test bodies were investigated for microcracks and rated according to the following rating scheme: 0=clean, 1=few micro cracks in some samples, 2=some micro cracks in all samples, 3=micro cracking in all samples, 4=macro cracking seen visually, 5=macro cracking in all samples seen visually. The results of the evaluation of the test bodies prepared is provided in the below table 1.

TABLE 1

| Composition of | Platform | Amount of | |
|---|---|---|---|
| powder | temperature | ceramic powder | rating |
| H13 only | 200° C. | 0 | 3 |
| H13 only | 150° C. | 0 | 3 |
| H13 + TiC | 200° C. | 0.2 | 1 |
| H13 + TiC | 200° C. | 0.4 | 0 |
| H13 + TiC | 175° C. | 0.4 | 0 |
| H13 + TiC | 165° C. | 0.4 | 0 |
| H13 + TiC | 150° C. | 0.4 | 1 |

As is apparent from the Table 1, the formation of cracks can significantly be reduced and even eliminated by the addition of TiC powder to the H13 steel alloy powder. In the case of 0.2 wt.-% TiC addition the cracks are significantly reduced compared to the test body prepared with H13 steel alloy powder at a platform temperature of 200° C. With 0.4 wt.-% TiC addition, no cracks were observed for test bodies prepared at platform temperatures of 200° C., 175° C. and 165° C. and also at 150° C. there was a significant reduction of the cracks compared to the test body prepared with H13 steel alloy powder at a platform temperature of 200° C.

In addition, if the platform temperature is lower, the tendency of the formation of cracks is higher.

### Example 2: Preparation of High and Low Load H13 Steel Test Bodies

Test bodies at high and low load (i.e. with a platform, on which the test bodies are built, so that the majority of the surface of the platform is covered by test bodies (high load) or with a platform, whereon less test bodies are prepared so that only a minor part of the platform is covered by the test bodies (low load)) were prepared using a powder mixture of H13 steel alloy powder and 0.4 wt.-% TiC (as in example 1). The process temperature for the preparation of the test bodies was 200° C. and a layer thickness of 40 μm was used. The test body thus prepared at high load did not show any visible cracking.

Two further test bodies were prepared with the same powder mixture as above at high load and at a platform temperature of 175° C. The first test body was prepared with a layer thickness of 30 μm, while the second test body was prepared with a layer thickness of 40 μm. When comparing the two test bodies, it was observed that the sample prepared at a layer thickness of 40 μm had less cracking than the sample prepared at a layer thickness of 30 μm. This is believed to be possibly due to the fewer exposure times to the part to heating/cooling cycles, which leads the reduction of cracking.

### Example 3: Preparation of AlCu4MgTi Alloy Test Bodies from Elemental Component Precursors

A composite material of the AlCu4MgTi alloy type was manufactured by dry mixing powders consisting mainly of one element or component, namely Al, Ag, Mg, Cu, TiC and Ti. The respective raw materials were obtained from commercial powder producers, except for the Ti obtained from EOS. The composition of the developed material, together with the purity levels and approximate median grain sizes (d50 value) of the raw materials (ingredients) are presented in Table 2.

TABLE 2
Composition of the developed powder with the purity
levels and d50 values of the raw materials

| | | | |
|---|---|---|---|
| Main component | wt-% | Purity [%] | d50 [μm] |

First material

| | | | |
|---|---|---|---|
| Al | 89.2 | >99.7 | 30 |
| Ag | 0.7 | >99.9 | 30 |
| Mg | 0.3 | >90 | 40 |
| Cu | 4.8 | >99 | 30 |
| Ti | 0.2 | >99.3 | 40 |

Second material

| | | | |
|---|---|---|---|
| TiC | 4.8 | >99.5 | 6 |

*Prior to sintering, the Mg powder was manually sieved using an 80 μm sieve mesh

The composite powder was fabricated by dry mixing the ingredients mechanically using a commercially available Merris SpinMix 550 blender with the mixing time of 90 min and mixing speed of approximately 20 rpm.

The composition as described in table 2 was processed to 3D-objects by DMLS in an EOS M290 machine. Appropriate DMLS processing parameters were determined by screening trials, which included building sample parts with varying values of laser output power P, laser hatch distance d and laser speed v. The heat input to the material while processing with a layer thickness S can be described as follows:

Q=P/(d*v*S)

The heat input factor Q is a measure of the amount of energy introduced per volume of the powder material. Heat input factor between 20 and 140 J/mm³ and laser spot size between 35 and 120 μm were found to lead to favourable properties of the manufactured objects.

The density of the test object was quantified by studying the sample crosscuts with an optical microscope, by which the possible defects, pores and cracks can be seen as optical contrast differences. The crosscuts were analyzed with an image capture/analysis software utilizing automatic histogram based filtering. The relative areal defect rates of different samples were quantitatively compared for the parameter optimization. In the test object, a high relative density was achieved. In the micrograph an evenly distributed darker phase, namely TiC could be detected.

The produced sample was free of pores and cracks. Only two scratches were detected which are caused by the grinding and polishing stage of sample preparation.

The tensile testing of the test objects was done according to EN ISO 6892-1: 2016, and the samples were machined according to ISO 6892-1: 2016(E) Annex D. The samples were tested both in the as-manufactured and heat treated (HT) state. In the as-manufactured state, samples built both in the horizontal direction (3 samples) and vertical direction (6 samples) were tested. In the heat-treated state, only horizontal samples were tested.

The heat treatments consisted of two steps: solution annealing and ageing. Two different heat treatments were tested. In the first heat treatment designated as long HT, the samples were solution annealed at 495° C. for 4 h, then at 505° C. for 6 h, then at 525° C. for 10 h and finally at 538° C. for 24 h. In a second heat treatment designated short HT, the samples were solution annealed at 495° C. for 1 h, then at 505° C. for 1.5 h, then at 525° C. for 5 h and finally at 538° C. for 12 h. Both the long and the short HT were followed by an ageing step at 190° C. for 4 h. For the long HT, three samples were tested. For the shortened HT, two samples were tested. The results of the mechanical testing including the ultimate tensile strength (Rm), yield strength (Rp0.2) and elongation (A) are provided in Table 3 below.

TABLE 3
Average tensile testing results of the developed
material composition in the as-manufactured state,
and after two different heat treatments.

| | Rm [Mpa] | Rp0.2 [Mpa] | A [%] |
|---|---|---|---|
| As-manufactured* | 370 | 265 | 12.2 |
| HT, long | 460 | 375 | 10.4 |
| HT, short | 475 | 370 | 10.3 |

*The values represent the averages of the vertical and horizontal building direction

As is evident from table 3, good mechanical properties were obtained in the as-manufactured test body. Upon heat treatment, the mechanical properties could be further improved significantly.

### Example 4: Preparation of a Test Body from an AlFeCrTi Alloy Powder

A composite material of an AlFeCrTi alloy type was manufactured by dry mixing powders of an AlFeCrTi-alloy (d50=35 μm) and a TiC powder (d50=1.4 μm). The AlFeCrTi-alloy had the following composition: 5.0 wt.-% Fe, 3.0 wt.-% Cr, 1.8 wt.-% Ti, 0.2 wt.-% Si, 0.04 wt.-% Mg, balance Al. The amount of TiC in the powder mixture was 0.8 wt.-%.

A solid object was prepared with this powder mixture as described in Example 3 above. The produced sample was free of pores and cracks.

Mechanical testing of the thus prepared test object was performed as described in Example 3 above, where the respective test objects were investigated both at room temperature (RT=23° C., according to EN ISO 6892.1 (2011)) and at a temperature of 250° C. (according to EN ISO 6892.2 (2011)). The results of the mechanical testing including the ultimate tensile strength (Rm), yield strength (Rp0.2) and elongation (A) are provided in Table 4 below.

TABLE 4
Average tensile testing results of the developed material
composition at room temperature and at 250° C.

| | Rm [Mpa] | Rp0.2 [Mpa] | A [%] |
|---|---|---|---|
| RT | 460 | 390 | 10 |
| 250° C. | 320 | 300 | 11 |

As is evident from the above table 4, the test body prepared exhibited good mechanical properties at both RT and 250° C.

### Example 5: Preparation of Test Bodies of Al7017 Alloy with TiC/B4C and Zr-Powder

For sample 5.1 below, a composite material of the Al7017 alloy type was manufactured by dry mixing powders of an Al7017 pre-alloy (d50=38 μm), B4C powder (d50=13 μm) and a Zr-powder (d50=30 μm). The Al7017 had the following composition: 0.42 wt.-% Si, 0.5 wt.-% Fe, 0.11 wt.-% Cu, 0.27 wt.-% Mn, 2.8 wt.-% Mg, 4.7 wt.-% Zn, and 0.23 wt.-% Zr (balance Al).

For sample 5.2, a dry powder mixture of an Al7017 pre-alloy (d50=48 μm) with the composition 0.44 wt.-% Si, 0.43 wt.-% Fe, <0.01 wt.-% Cu, 0.24 wt.-% Mn, 2.5 wt.-% Mg, 4.6 wt.-% Zn, and 0.2 wt.-% Zr (balance Al) was used in addition to TiC and Zr-additives. In this sample, the respective additives were a Zr-powder (d50=30 μm) and TiC powder (d50=1.4 μm). All respective raw materials were obtained from commercial powder producers. The composition of the powder mixtures are provided in the below Table 5.

TABLE 5
Compositions of the powder mixtures

| | Sample 5.1 | Sample 5.2 |
|---|---|---|
| Al-alloy powder | balance | balance |
| TiC (μm) | | 0.7 |
| B₄C | 0.6 | |
| Zr | 3.0 | 3.0 |

The powder mixture was fabricated by dry mixing the ingredients mechanically using a commercially available Merris SpinMix 550 blender with the mixing time of 90 min and mixing speed of approximately 20 rpm.

The compositions as described in table 1 were processed to 3D-objects by DMLS in an EOS M290 or M280 machine as described in Example 3. A heat input factor between 20 and 140 J/mm³ and laser spot size between 35 and 120 μm were found to lead to favourable properties of the manufactured objects.

The density of the test objects was quantified as described in Example 3. In the micrographs evenly distributed darker phases and phases of different darkness and about comparable size could be seen, which are evenly distributed in the structure. The produced samples were free of pores and cracks.

The thus prepared samples were subjected to a subsequent heat treatment at 440° C. for 60 Min followed by quenching in water and a final aging at 120° C. for 24 h.

The tensile testing and sample preparation of the test objects was done as described in Example 3. The samples were built in the horizontal direction and were tested both in the as-manufactured and heat treated (HT) state.

The results of the mechanical testing including the ultimate tensile strength (Rm), yield strength (Rp0.2) and elongation (A) are provided in Table 6 below.

TABLE 6
Average tensile testing results of the developed material composition
in the as-manufactured state and after heat treatment.

| | | |
|---|---|---|
| Rm [Mpa] | Rp0.2 [Mpa] | A [%] |

Sample 5.1

| | | | |
|---|---|---|---|
| As-manufactured | 330 | 260 | 12 |
| HT | 490 | 460 | 6 |

Sample 5.2

| | | | |
|---|---|---|---|
| As-manufactured | 345 | 335 | 4.5 |
| HT | 480 | 475 | 8 |

As is apparent from the above, the further heat treatment provides a significant increase in both the tensile and yield strength.

### Example 6: Preparation of Test Bodies of Al7075 Alloy with B₄C Powder

A composite material of the Al7075 alloy type was manufactured by dry mixing powders of an Al7075 pre-alloy (d50=48 μm), a Zr-powder (d50=30 μm) and a B₄C powder (d50=13 μm). The Al7075 had the following composition: 0.08 wt.-% Si, 0.17 wt.-% Fe, 0.22 wt.-% Cr, 1.7 wt.-% Cu, 0.008 wt.-% Mn, 2.0 wt.-% Mg, 5.3 wt.-% Zn, and 0,004 wt.-% Zr (balance Al). The respective raw materials were obtained from commercial powder producers. The composition of the powder mixtures are provided in the below Table 7.

TABLE 7
Composition of the powder mixture

| | Sample 5 |
|---|---|
| Al-alloy powder | balance |
| Zr | 4.0 |
| B₄C | 0.8 |

The powder mixture was fabricated by dry mixing the ingredients mechanically using a commercially available Merris SpinMix 550 blender with the mixing time of 90 min and mixing speed of approximately 20 rpm.

The composition as described in table 7 was processed to 3D-objects by DMLS in an EOS M290 machine. Appropriate DMLS processing parameters were determined by screening trials, which included building sample parts with varying values of laser output power P, laser hatch distance d and laser speed v as describes in example 1, were also a heat input factor of between 20 and 140 J/mm³ and a laser spot size between 35 and 120 μm were found to lead to good properties of the manufactured objects. The produced samples were free of pores and cracks.

The thus prepared samples were subjected to a subsequent heat treatment of 440° C. for 60 Min followed by quenching in water and a final aging at 120° C. for 24 h.

The tensile testing of the test objects was done as described in Example 3. The results of the mechanical testing including the ultimate tensile strength (Rm), yield strength (Rp0.2) and elongation (A) are provided in Table 8 below.

TABLE 8
Average tensile testing results of the developed material composition
in the as-manufactured state and after heat treatment.

| | Rm [Mpa] | Rp0.2 [Mpa] | A [%] |
|---|---|---|---|
| As-manufactured | 336 | 292 | 9 |
| HT | 566 | 559 | 3 |

### Example 7: Preparation of Test Bodies of a Nickel HX Alloy with TiC

A composite material of the nickel HX alloy type was manufactured by dry mixing powders of EOS nickel HX powder and a TiC powder (d50=6 μm), which accounted for 1.45 wt.-% of the mixture. The nickel HX alloy had a maximum content of particles in excess of 63 μm of 0.5 wt.-%. For reference, a material consisting only of EOS nickel HX powder was used. The respective raw materials were obtained from commercial powder producers.

The powder mixture was fabricated by dry mixing the ingredients mechanically using a commercially available uniaxial rotating mixer for 20 min at 15 rpm.

The compositions were processed to 3D-objects by DMLS in an EOS M290 machine. Appropriate DMLS processing parameters were determined by screening trials, which included building sample parts with varying values of laser output power P, laser hatch distance d and laser speed v as describes in example 1. The produced samples were free of pores and cracks.

The thus prepared samples were subjected to a subsequent heat treatment of 1175° C. for 60 Min followed by cooling to ambient temperature on a ZrO sand bed.

The tensile testing of the test objects was done according to EN ISO 6892-1: 2009: B10, Part 1: Method of test at room temperature. The samples were tested in the heat treated (HT) state both in the horizontal and vertical direction. The results of the mechanical testing including the tensile strength (Rm) and yield strength (Rp0.2) are provided in Table 9 below as an average of three tests each.

TABLE 9
Tensile testing results of the developed material
composition after heat treatment.

| | Rm [Mpa] | Rp0.2 [Mpa] |
|---|---|---|
| HX HT, horizontal | 747 | 355 |
| HX HT, vertical | 638 | 345 |
| HX + TiC HT, horizontal | 985 | 574 |
| HX + TiC HT, vertical | 906 | 521 |

As can be seem from table 9, the objects prepared with TiC as an additive had notably increased tensile and yield strength values in both manufacturing directions.

1. Powder mixture for use in the manufacture of a three-dimensional object by an additive manufacturing method, wherein the powder mixture comprises a first material of a metal alloy or a mixture of elemental precursors thereof and a second material of a reinforcement material comprising powder particles having a particle diameter of from 1 to less than 30 μm (as determined by laser scattering or laser diffraction), wherein the mixture comprises about 0.1 to about 10.0 wt.-% of the second material.

2. Powder mixture according to claim 1, wherein the second material comprises at least one reinforcement material selected from the group of borides, carbides, nitrides, oxides and silicides.

3. Powder mixture according to claim 1 comprising about 0.15 wt.-% or more, and/or about 7.0 wt.-% or less of the second material.

4. Powder mixture according to claim 1, wherein the particles of the second material include at least one member selected from the group consisting of substantially spherical and substantially irregular.

5. Powder mixture according to of claim 1, wherein the first material comprises iron and 4.75 to 5.5 wt.-% Cr, 1.0 to 1.75 wt.-% of Mo and 0.32 to 0.45 wt.-% of C and further comprises one or more of 0.8 to 1.25 wt.-% of Si, 0.8 to 1.2 wt.-% of V, 0.2 to 0.6 wt.-% of Mn, up to 0.05 wt.-% of P and 0.05 wt.-% of S.

6. Powder mixture according to of claim 1, wherein the first material comprises aluminium and 4.0 to 5.0 wt.-% Cu, 0.15 to 0.35 wt.-% Ti and 0.15 to 0.35 wt.-% Mg and 0.4 to 1.0 wt.-% Ag.

7. Powder mixture according to claim 1, wherein the first material comprises aluminium and 4.0 to 5.2 wt.-% Zn, 2.0 to 3.0 wt.-% Mg, up to 0.45 wt.-% Fe, up to 0.50 wt.-% Si, and one or more of up to 0.35 wt.-% of Cr, up to 0.5 wt.-% of Mn, up to 0.1 wt.-% of Ni, up to 0.15 wt.-% of Ti and up to 0.25 wt.-% of Zr, provided that the combined amount of Mn and Cr is >0.15 wt.-%.

8. Powder mixture according to claim 1, wherein the first material comprises aluminium and 0.8 to 1.2 wt.-% Mg, 0.4 to 0.81 wt.-% Si, 0.15 to 0.4 wt.-% Cu, 0.04 to 0.35 wt.-% Cr, one or more of up to 0.7 wt.-% Fe, up to 0.15 wt.-% Mg, up to 0.25 wt.-% Zn and up to 0.15 wt.-% Ti.

9. Powder mixture according to claim 1, wherein the first material comprises aluminium and 1 to 6 wt.-% Fe, 1.3 to 7.5 wt.-% of Cr, and 1.2 to 4 wt.-% of Ti, and up to 0.5 wt.-% of Si and up to 0.1 wt.-% of Mg.

10. Powder mixture according to claim 1, wherein the first material comprises aluminium and 4.0 to 6.1 wt.-% Zn, 1.5 to 3.0 wt.-% Mg, up to 0.8 wt.-% Fe, up to 0.60 wt.-% Si, and one or more of up to 0.35 wt.-% of Cr, up to 0.5 wt.-% of Mn, up to 2.0 wt.-% of Cu, up to 0.30 wt.-% of Ti and 0.1 to 0.25 wt.-% of Zr.

11. Powder mixture according to claim 10, wherein the first material comprises less than or equal to 0.25 wt.-% of Cu, less than or equal to 0.35 wt.-% of Cr, and 0.05 to 0.5 wt.-% of Mn, and wherein the combined amount of Mn and Cr is >0.15 wt.-%.

12. Powder mixture according to claim 1, wherein the first powder has a particle size distribution with a d50 of from 20 to 100 μm.

13. Process for the production of a powder mixture according to claim 1, wherein the powder mixture is produced by mixing the first powder and the second powder in a predetermined ratio, wherein the mixing is by dry mixing.

14. Process for the manufacture of a three-dimensional object, comprising providing a powder mixture as defined in claim 1 and preparing the object by applying the mixture layer on layer and selectively consolidating the mixture, in particular by application of electromagnetic radiation, at positions in each layer, which correspond to the cross section of the object in this layer, wherein the positions are scanned in a radiation interaction zone of an energy beam bundle.

15. Process according to claim 14, wherein the mixture prior to solidifying is heated to a temperature of 100° C. or more.

16. Process according to claim 14, wherein the individual layers are applied at a thickness of 10 μm or more and/or 100 μm or less.

17. Three-dimensional object prepared according to the process of claim 14.

18. Three-dimensional object, which is constituted of a metal alloy as defined in claim 5 as a matrix comprising particles of a reinforcement material having a particle diameter of 1 μm to less than 30 μm, wherein the reinforcement material accounts for 0.1 to about 10.0 wt.-% of the three dimensional object.

19. Three-dimensional object according to claim 17, having a relative density of 98% or more, wherein the relative density is defined as the ratio of the measured density and the theoretical density.

20. Use of a powder mixture according to claim 1 for minimizing and/or suppressing crack formation of in a three-dimensional object, wherein the three-dimensional object is prepared in a process involving the step- and layerwise build-up of the three-dimensional object by additive manufacturing.

21. Device for implementing a process according to claim 14, wherein the device comprises a laser sintering or laser melting device, a process chamber having an open container with a container wall, a support, which is inside the process chamber, wherein open container and support are moveable against each other in vertical direction, a storage container and a recoater, which is moveable in horizontal direction, and wherein the storage container is at least partially filled with a powder mixture.
